(19) United States
(12) Patent Application Publication
(10) Pub. No.: US 2018/0005247 A1
(43) Pub. Date: Jan. 4, 2018

(54) METHOD AND SYSTEM OF ON-LINE REAL-TIME SHADOWING FOR CONTEXT AWARE USER RELATIONSHIP MANAGEMENT

(71) Applicant: INTERDIGITAL TECHNOLOGY CORPORATION, Wilmington, DE (US)

(72) Inventors: Shoshana Loeb, Philadelphia, PA (US); Kuo-Chu Lee, Princeton Junction, NJ (US); Zijun Yao, North Arlington, NJ (US)

(73) Assignee: INTERDIGITAL TECHNOLOGY CORPORATION, Wilmington, DE (US)

(21) Appl. No.: 15/538,223

(22) PCT Filed: Dec. 29, 2015
(86) PCT No.: PCT/US2015/067795

§ 371 Date: Jun. 21, 2017

Related U.S. Application Data
(60) Provisional application No. 62/097,427, filed on Dec. 29, 2014.

(51) Int. Cl. G06Q 30/00; G06F 17/30; G06Q 10/06; G06Q 10/10

(52) U.S. Cl. CPC G06Q 30/016; G06Q 10/105; G06F 17/30029; G06Q 10/06

(57) ABSTRACT

Methods and systems are disclosed herein to provide real-time shadowing service architectures and workflows to support dynamic event pattern parameter configuration, collection, filtering, learning, and profiling for users of one or more interactive platforms. The real-time shadowing service may receive a subset of application specific tags, generate tag values for the tags in the subset based on user behavior, and report the values for the tags in the subset. Further, the real-time shadowing service may collect data based on a list of tags for an engagement level related parameter vector (E.V.) and a competence level related parameter vector (C.V.). Further, the real-time shadowing service may map E.V. and C.V. for an event of interest (EoI) to an engagement level (E.L.) and competence level (C.L.) based on a model. The real-time shadowing service may also generate alerts based on detection rules, E.L. and C.L., and transmit the alerts.

### CROSS REFERENCE TO RELATED APPLICATIONS

This application claims the benefit of U.S. Provisional Application No. 62/097,427 filed on Dec. 29, 2014, the contents of which are hereby incorporated by reference herein.

### BACKGROUND

The proliferation of mobile applications and games combined with new wearable device sensors has created pervasive three-dimensional (3D) augmented/virtual reality worlds that may support complex interactions between user applications under rich applications and environment contexts. Many mobile applications and games have rich sets of contexts, but may have relatively short lifecycles. If a user does not have a good experience in using an application, the user may delete the application within a few tries. Further, the rich context provided by these applications and games may increase the types of problems that the users might encounter. It may be a challenge to effectively manage the cost of real-time user behavior for these mobile applications and games that are rich in context but short in lifecycle.

Effective user relationship management may require an in-depth understanding of users and detecting user behavior under different circumstances in real-time. Customer retention services may collect, learn, and detect customer behavior, and provide remediation actions to improve customer retention for multiple types of applications and games.

### SUMMARY

Embodiments may include a method, system, and apparatus for detecting user behavior patterns across one or more interactive platforms having diverse data sources and contexts. The embodiments may include: performing real-time shadowing of interaction event patterns between the user and the interactive platform, wherein the interaction event patterns are selected dynamically using a dynamic Event Parameter Filter (DEPF); and deriving high-level behavior indicators of the user for user relationship management.

The embodiments may further include defining an active Event of Interest (EoI) object model to capture events of interest generated from a finite state transition in the interactive platform caused by an event or user input. The EoI object model may be linked with the DEPF and user behavior parameters represented in vector form by extracted therefrom.

The embodiments may further include: initiating a list of tags for a user's engagement level related parameter vector (E.V.) and a list of tags for a competence level related parameter vector (C.V.); loading the tags to a uniform resource identifier (URI); collecting, by a parameter filer (PF), event data based on the tags loaded to the URI; parsing, by a metric filter, tag values for the tags loaded to the URI; generating, by the metric filter, the E.V. and the C.V. based on the tag values; generating, by a profiler, a model to map the E.V. and the C.V. to an engagement level prime (E.L.′) and competence level prime (C.L.′) based on a range of values; storing the model, the E.L.′, and the C.L.′ in a profile database; adjusting the weights for the tags based on the model and profile data in the profile database; posting the adjusted weights and tags to the URI; mapping, by the metric filter, the E.V. and the C.V., to an engagement level (E.L.) and competence level (C.L.) in real-time using the model; and generating alerts using detection rules based on the E.L., the C.L., the E.L.′ and the C.L.′.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an example of a small-cell backhaul in an end-to-end mobile network infrastructure;

FIG. 1E is a system diagram of an example communications system in which one or more disclosed embodiments may be implemented;

FIG. 2 is a diagram illustrating a service rule template use case;

FIG. 3 is a diagram illustrating real-time shadowing for context aware user relationship management;

FIG. 4 is a flow chart illustrating iterative engagement and competence vector [E.V., C.V.] provisioning, filtering, and profiling steps;

FIG. 5 is a diagram illustrating shadowing support services for distributed parameter filters; and

FIG. 6 is a diagram illustrating context aware on-line help services.

### DETAILED DESCRIPTION

Effective user relationship management may require in-depth understanding of users and the detection of user behavior under different circumstances in real-time. Embodiments described herein may include customer retention services to collect, learn, and detect user behavior and provide remediate actions to improve user retention for multiple types of interactive platforms, such as applications and games. Disclosed herein are methods, service architectures, and workflows to off-load complex context aware user relationship management from the application and game developers in a resource and cost effective manner.

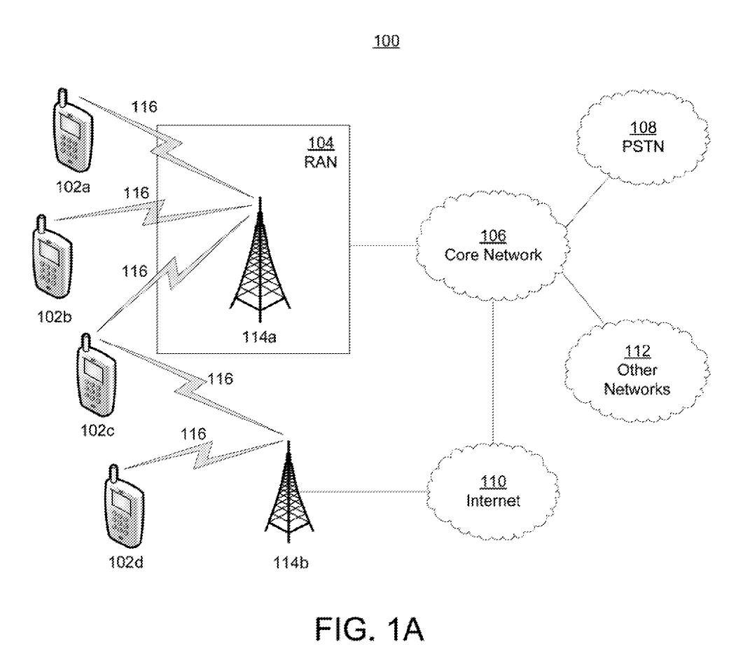

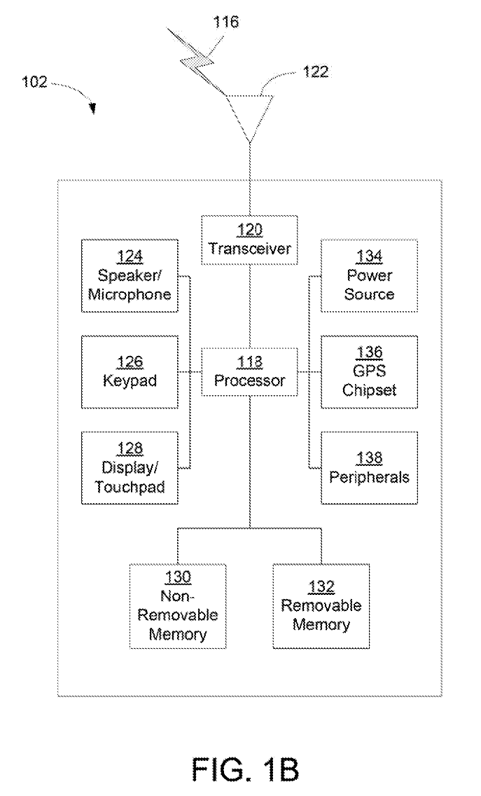

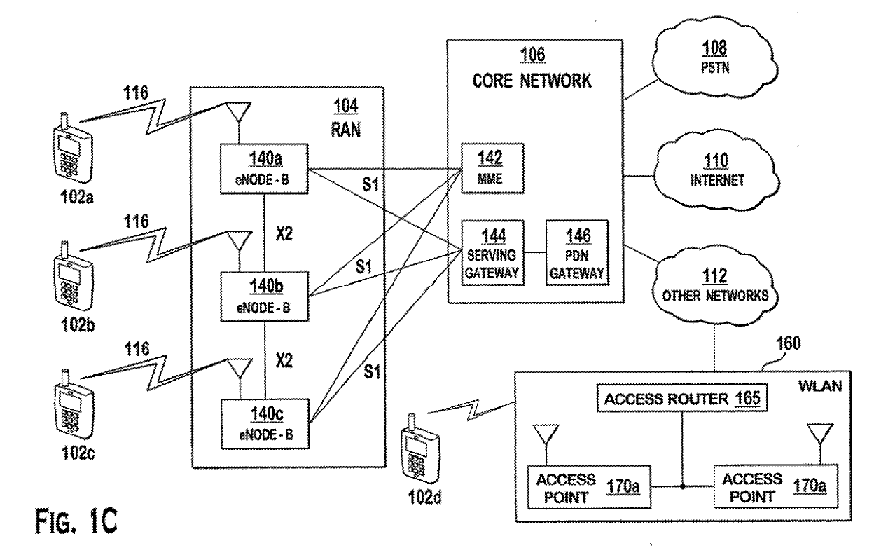

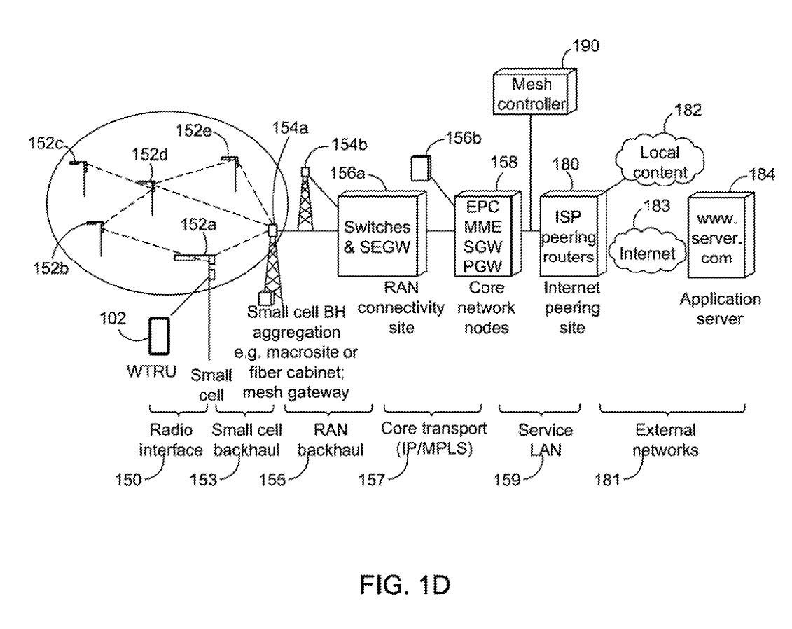

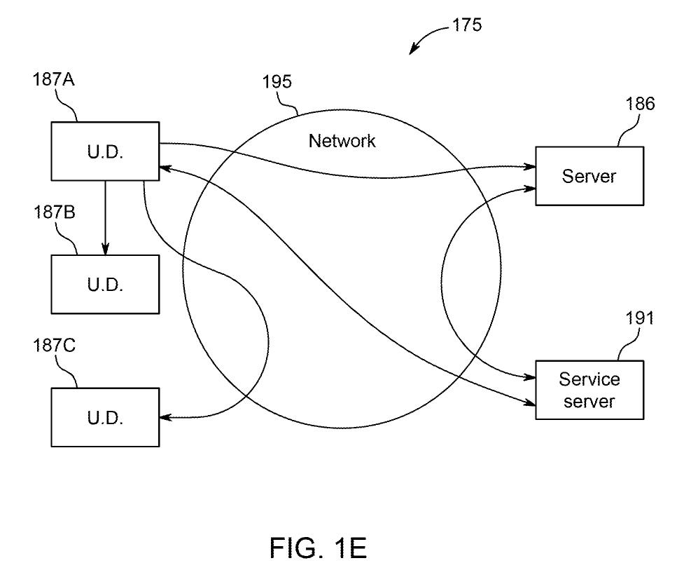

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an Si interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the Si interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Other network 112 may further be connected to an IEEE 802.11 based wireless local area network (WLAN) 160. The WLAN 160 may include an access router 165. The access router 165 may contain gateway functionality. The access router 165 may be in communication with a plurality of access points (APs) 170a, 170b. The communication between access router 165 and APs 170a, 170b may be via wired Ethernet (IEEE 802.3 standards), or any type of wireless communication protocol. AP 170a may be in wireless communication over an air interface with WTRU 102d.

FIG. 1D is a system diagram of an example of a small-cell backhaul in an end-to-end mobile network infrastructure. A set of small-cell nodes 152a, 152b, 152c, 152d, and 152e and aggregation points 154a and 154b interconnected via directional millimeter wave (mmW) wireless links may comprise a “directional-mesh” network and provide backhaul connectivity. For example, the WTRU 102, or multiple such WTRUs, may connect via the radio interface 150 to the small-cell backhaul 153 via small-cell 152a and aggregation point 154a. In this example, the aggregation point 154a provides the WTRU 102 access via the RAN backhaul 155 to a RAN connectivity site 156a. The WTRU 102 therefore then has access to the core network nodes 158 via the core transport 157 and to internet service provider (ISP) 180 via the service LAN 159. The WTRU also has access to external networks 181 including but not limited to local content 182, the Internet 183, and application server 184. It should be noted that for purposes of example, the number of small-cell nodes 152 is five; however, any number of nodes 152 may be included in the set of small-cell nodes.

Aggregation point 154a may include a mesh gateway node. A mesh controller 190 may be responsible for the overall mesh network formation and management. The mesh-controller 190 may be placed deep within the mobile operator's core network as it may responsible for only delay insensitive functions. In an embodiment, the data-plane traffic (user data) may not flow through the mesh-controller. The interface to the mesh-controller 190 may be only a control interface used for delay tolerant mesh configuration and management purposes. The data plane traffic may go through the serving gateway (SGW) interface of the core network nodes 158.

The aggregation point 154a, including the mesh gateway, may connect via the RAN backhaul 155 to a RAN connectivity site 156a. The aggregation point 154a, including the mesh gateway, therefore then has access to the core network nodes 158 via the core transport 157, the mesh controller 190 and to ISP 180 via the service LAN 159. The core network nodes 158 may also connect to another RAN connectivity site 156b. The aggregation point 154a, including the mesh gateway, also may connect to external networks 181 including but not limited to local content 182, the Internet 183, and application server 184.

FIG. 1E is a system diagram of an example communications system 175 in which one or more disclosed embodiments may be implemented. In some embodiments, communications system 175 may be implemented using all or a portion of system 100 as shown and described with respect to FIG. 1A.

User device 187a, server 186, and/or service server 191 may communicate over a communication interface, such as communications network 195. These communications may be wireless, wired, or any combination of wireless and wired. Communications network 195 may include the internet 110, core network 106, other networks 112, or any other suitable communications network or combination of communications networks.

User device 187a may include a WTRU (such as WTRU 102a), or any suitable user computing and/or communications device such as a desktop computer, web appliance, interactive television (ITV) device, gaming console (such as Microsoft XBOX™ or Sony Playstation™) or the like. User device 187a and/or applications executing on user device 187a may generate events such as mouse clicks, keyboard strokes, and the like. These events may be processed by user device 187a and/or may be transmitted to another device such as server 186 or service server 191.

Server 186 may include a web server, application server, data server, or any combination of these or other types of servers. Server 186 may include any suitable server device such as a server computer, personal computer, or the like. The server 186 may include a processor operatively coupled to a memory. The processor may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform signal coding, data processing, power control, input/output processing, and/or any other functionality that enables the server 186 to operate in communications network 195. The memory may store an electronic request processing application that receives a request from the user device 187a over the communications network 195.

The server 186 may host applications accessible to user device 187a. For example, server 186 may include a gaming server hosting a massively multiplayer online game (MMOG), an email server, a web server hosting a website such as a social media website or blog, or other types of servers typically accessible by a user device over a computer communications network.

User device 187a may access server 186 over computer communications network 175 to interact with services that it provides. For example, user device 187a may access a game server hosted on server 186 to participate in a multiplayer online game. Access of server 186 by user device 187a may be via a client application executing on user device 187a or any other suitable mechanism. In some cases, the server 186 may receive events from user device 187a, or may send events to user device 187a. For example, the server 186 may send an event to user device 187a indicating that additional in-game resources are required for continued play.

Service server 191 may include a web server, application server, data server, or any combination of these or other types of servers hosted on a server device. Service server 191 may include any suitable server device such as a server computer, personal computer, or the like. The service server 191 may include a processor operatively coupled to a memory. The processor may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform signal coding, data processing, power control, input/output processing, and/or any other functionality that enables the service server 191 to operate in communications network 195. The memory may store an electronic request processing application that receives a request from the server 186 or a user device 187a over the communications network 195.

Service server 191 may be configured to communicate with server 186, for example, over network 195 or any other suitable communications medium. Service server may be co-located with, combined with, or in direct communication with server 186.

Service server 191 may communicate with server 186 to provide services, such as third party services, to users of server 186. For example, a subscriber to a game hosted on server 186 may access server 186 from user device 187a and may subscribe to third party services for the game which are hosted on service server 191.

Service server 191 may be configured to receive and/or intercept events transmitted between user device 187a and server 186. For example, in some embodiments server 186 and service server 191 may be configured such that server 186 may send an event destined for user device 187a instead or additionally to service server 191, and service server 191 may send the event or another event, signal, or message to device 187a. For instance, in a case where server 186 includes a game server, server 186 may send an event to service server 191 indicating a requirement of a user of user device 187a, and server 191 may send the event or another signal or message to device 187a indicating that a resource is available to acquire the requirement. In some embodiments, service server 191 may only forward the event to device 187a under certain conditions, such as based on a user preference and/or context information relating to the user of device 187a.

In some embodiments, the functions of service server 191 and server 186 may be implemented using the same device, or across a number of additional devices.

In some embodiments, user devices 187b and 187c may communicate with server 186 and/or service server 191 via user device 187a. For example, user device 187a may forward a notification message from service server 191 to user device 187b via a peer to peer connection and may forward a notification message from service server 191 to user device 187c via network 195. In some embodiments, user devices 187a, 187b, and 187c may form a network, such as a peer-to-peer network, and such network may have a mesh topology, a star topology using user device 187a as a coordinating node, or any other suitable topology. In such embodiments, the peer-to-peer network may operate independently of server 186 and/or service server 191, and may incorporate functionality that otherwise would be hosted by server 186 and/or service server 191, such as functionality described herein.

Methods and systems are disclosed herein to provide a unified service to learn and detect user behavior patterns for multiple applications and games with diverse types of data source and contexts. Embodiments may include a user relationship management service that may learn user behavior over time and may consist of a set or sets of behavior detection rules to detect various user behavior patterns.

To provide efficient behavior pattern detection rules, the methods and systems disclosed herein may use high-level pattern variables to represent behavior indicators that are important to user relationship management concerns. For example, a user's engagement and competence levels may be important indicators for deciding if the user might require on-line help or support. When a user's level of engagement or competence decreases below the normal levels learned from the user's historical behavior, the system may investigate if there are network problems that hinder the user's competence or if it is necessary to provide further assistance to the user to improve productivity and customer satisfaction.

The high-level behavior pattern indicators, such as competence level and engagement level, may provide the right level of abstraction for user relationship management operation staffs and data analysts and may be applied to many application and game contexts. As used herein, an attribute may refer to a tag or parameter, and the terms may be used interchangeably.

To support the high-level behavior indicators, efficient methods and services may be used to collect lower level parameters in each application and game. These in-application and in-game parameters may have diverse types and may often be associated with specific contexts, such as location in the virtual or physical world. For example, the engagement level may include session time, session frequency, and the pace of the user interactions depending on different devices and locations. The competence level may include win/loss rate, damage-to-self or damage-to-others, kill rate, time to completion, and many other variations. As a result, significant efforts may be involved to implement customized workflows to collect, analyze, learn, and derive the high-level behavior indicators.

Conventional mobile application and game analytics products may provide software development kits (SDKs) and backend analytic services tools (e.g., GOOGLE ANALYTICS and FLURRY) to collect, analyze and report usage and behavior metrics based on user defined parameters in the events. Developers may embed the data collection SDK codes in design and development time, and may only collect the data after the application is deployed to the end users. Analytic results on user behavior obtained from the analytic tools or services may often lag behind the development cycle. Developers may only modify the application based on the behavior analysis results off-line on the new versions of software releases. This delay may significantly affect the responsiveness of real-time detection and remedial action required for user relationship management.

In addition, effective design and deployment of behavior pattern detection rules may require collaboration between a data analyst and the application developer. For example, the detection of engagement level or competence level may require a substantial amount of effort from developers to identify, analyze, and classify parameters that are required to derive the application independent behavior indicators for each application and game context.

Embodiments described herein may include real-time shadowing service architectures and workflows to support dynamic event pattern parameter configuration, collection, filtering, learning, and profiling. The shadowing service may provide an easy to use service interface for developers and customer relationship management (CRM) specialists to gain a deeper understanding of users' behavior by virtually “shadowing” the interactions between the users and the application.

Virtual “Shadowing” may be analogous to learning by following a mentor. Using shadowing, the system may learn how user responds to the application events, learn how a user initiates actions, and record the learned event and action patterns. The shadowing service may support close observation and learning of multiple users' interaction event patterns for multiple types of applications.

Embodiments may utilize open service interfaces for users and developers to provision a set of interaction event parameters required to derive the high-level behavior indicators such as engagement and competence levels. A dynamic configurable Event Parameter Filter (EPF) may probe and filter parameters generated from in-application and in-game interactions, and may support the dynamic selection of different parameters from the applications. Different from an in-game inspector or a game artificial intelligence (AI) agent, which may be programmable at design time by a game developer, the EPF may provide an interface for dynamic configuration from remote locations by external service entities. The dynamic service interface may support selection and filtering of a subset of user interaction event parameters from the application and send the parameter to the shadowing service.

The real-time context aware user behavior shadowing services may have many features and benefits. For example, the high-level behavior indicator based pattern detection rules may be transparent and applicable to multiple low level in-application and in-game parameters. This may improve the productivity and effectiveness of user relationship management specialists by specifying rules that detect the specific indicators that is effective for specific user in specific application and game contexts. In addition, this may off-load the application dependent details from the high-level user relationship management development to improve operation agility.

In addition, the cross application and game real-time user behavior shadowing service may consolidate the analysis, learning, and behavior detection efforts from multiple independent repetitive processes for each application and game to one integrated service for multiple applications and games. This may improve the accuracy by iterative refinements on parameter selection and analysis methods. This may also off-load the behavior learning, and analysis efforts from developers.

In addition, Dynamic Event Parameter Filters (DEPF) may support an open interface for selection of behavior parameters needed for user behavior relationship management. This may reduce the development and operation cost involved in software revisions as well as the communication and processing cost by selecting subset of in-application and in-game parameters tailored to the context of each application and games dynamically. This may also off-load the application developer from the user relationship management support functions and allow dynamic selection of behavior parameter collection by the user behavior analysis specialist

In addition, the easy to use and extensible data model template may support iterative refinement of behavior parameter filtering, behavior metric analysis, and behavior indicators classifications. An Active Event of Interest (EoI) object model may be defined to capture events of interest (e.g., a monster is killed) generated from Finite State transitions caused by inputs from user action or application events. There may be a dynamic linkage of the EoI object model with the EPF to extract behavior parameters represented in vector form. For example, engagement and competence related parameter vectors may be denoted as [E.V., C.V.]). Interface methods may be provided to support dynamic provisioning and iterative refinement of [E.V., C.V.] and EoI for multiple applications and games.

In addition, extended behavior shadowing features may be used for on-line help support. Automated on-line help content may include pre-recording and search functions (e.g., how to kill a monster) based on [E.V., C.V.] and [EoI] (e.g., monster is killed). Comparative user behavior analysis may cross multiple applications and games to detect engagement or competence level of users in different games.

In addition, an automated iterative parameter reduction and weight adjustment may reduce the dependency on data analysts and may improve the accuracy and effectiveness of user relationship management against operation objectives such as retention rate, user satisfaction, improvement on user performance, and purchase of premium packages.

Embodiments described herein may include easy to use application independent detection templates that may be used for different applications and games. These templates may support the rapid deployment of context aware user relationship management.

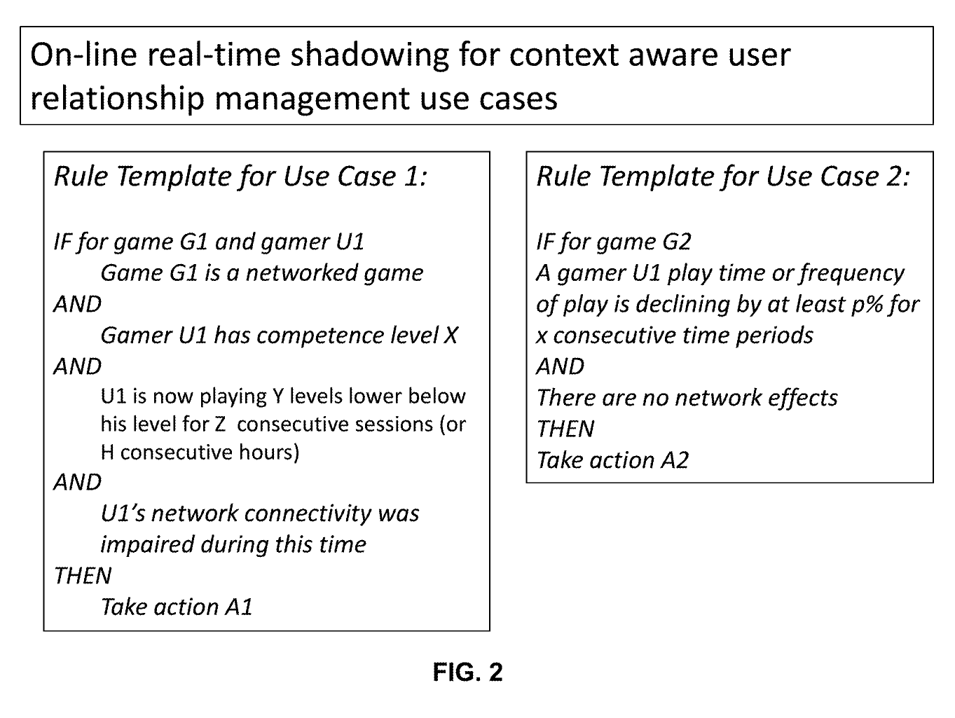

Referring now to FIG. 2, a diagram illustrating a service rule template use case is shown. The engagement and competence level detection rules shown in FIG. 2 may contain an application-independent pattern specification for network impairment detection. In an embodiment, the application-independent pattern specification may be predicated on high-level application independent user behavior indicators, such as levels of engagement and competence and the corresponding historical average levels.

The user behavior indicators may be learned and derived from multiple application-specific parameters. Users may configure one or more constants in the detection rules templates without significant effort or training. It may also be possible to define rules predicated on competence level improvement rates in combination with the engagement level and other high-level user behavior independent indicators for multiple applications and games. Embodiments described herein may include a shadowing service that may collect, filter, learn, and classify application-dependent parameters and produce the behavior indicators supporting the high-level design and configuration of the detection rules templates.

The following embodiments may include real-time context aware shadowing service architecture. The shadowing service may consist of a provisioning service, DEPFs, an event metric filter, a behavior profiler and a user behavior detection rules service.

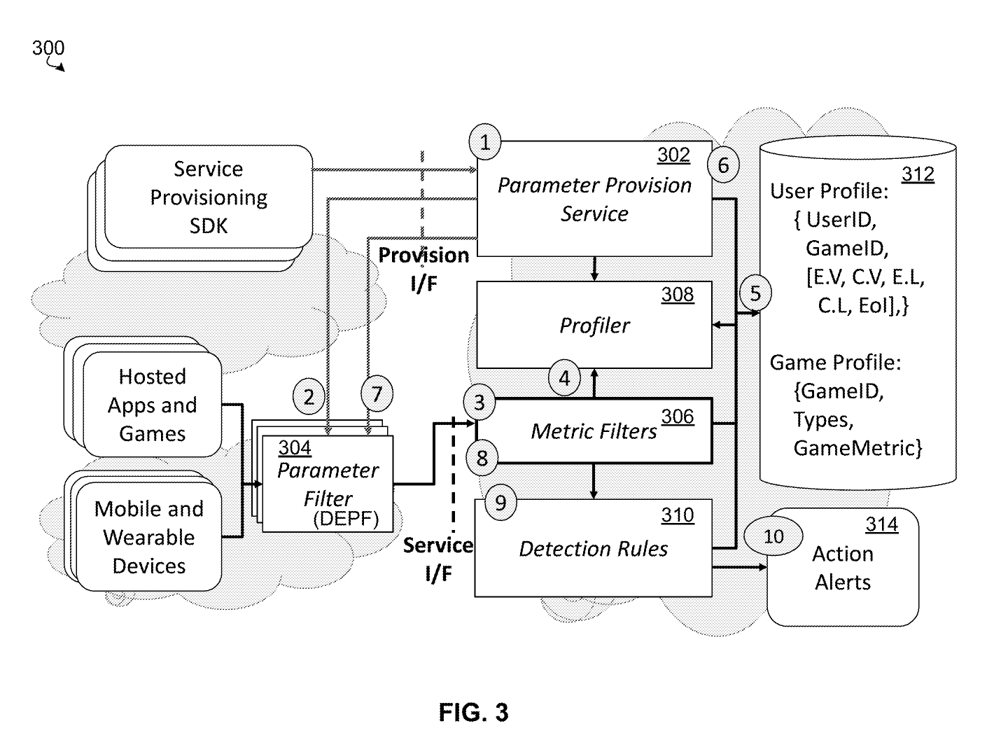

Referring now to FIG. 3, a diagram illustrating real-time shadowing for context aware user relationship management is shown. The virtual shadowing service 300 shown in FIG. 3 may address the complexity of context aware data collection, filtering, profiling and detection workflow efficiency.

The virtual shadowing service 300 may be hosted on a server, such as, for example, the server 186 and/or the service server 191 as described above with reference to FIG. 1E. The virtual shadowing service 300 may include a provisioning service 302. The provisioning service 302 may provide easily configurable application-specific parameters and behavior indicator mapping templates for users, application and game developers, and/or user relationship management specialists to control function modules of the virtual shadowing service 302 in the run time. The function modules of the virtual shadowing service 302 may be controlled by the users, application and game developers, and/or user relationship management specialists over a communications interface, such as, for example, the communications network 195 as described above with reference to FIG. 1E.

The application and game developers may define and change parameters related to each high-level user behavior indicator for each application and game. The user relationship management specialist may define and describe the semantics of each high-level behavior indicator and create a mapping template for application and game developers to enter the application-specific parameters related to the behavior indicator. A mapping table example is described further below.

The virtual shadowing service 300 may include a Dynamic Event Parameter Filter (DEPF) 304. The DEPF 304 may take a configuration of the type of parameters that are to be extracted from the application and sent to the shadowing service. For example, application and game developers may select a subset of parameters such as a “performance score” to assess user competence. Finite State Machine (FSM) transition events tuples may provide an application independent format for reporting user behavior parameters. The output of the filter may be a tuple consisting of FSM transition events and parameters extracted based on a provisioned configuration. Further related examples are provided below.

The virtual shadowing service 300 may include an event metric filter 306. The event metric filter 306 may take a configuration from the provisioning service 302 to process the input parameters and events sent from the DEPF 304. The outputs of the metric filter 306 may be statistics about the parameters, such as, for example, the average and the standard deviation within a moving window. For example, the average kill rate for the last few sections may be used as an indicator of competence.

The virtual shadowing service 300 may include a behavior profiler 308. The behavior profiler 308 may obtain configurations from the provisioning service 302 to select an algorithm or a process to profile the metric data calculated by the metric filter 306. Example outputs of the profiler may include, but are not limited to, the following: a model for deciding the level of behavior indicators, a relevance or correlation between metrics of the parameters and the behavior indicators, and the level classification for the behavior indicators, such as [1:10]. The behavior profiler 308 may store the behavior indicators, an engagement level prime (E.L.′) value and a competence level prime (C.L.′) value in a profile database 312 for each user or group of user based on one or more EoIs. The output of the relevance or correlation may also be used by the provisioning service 302 to recommend parameter selection for the DEPF 304 and the metric filter 306.

The virtual shadowing service 300 may include a behavior detection rules service 310. The user behavior detection rules service 310 may take instantiated rules from the rules template provided by the provisioning service 302 and perform real-time detection of a user's behavior indicator against a behavior indicator statistical model learned from the metric filter 306 and the profiler 308. When a detection rule is fired, action may be sent to an action-processing module 314 for decisions on how to fulfill the detected user relationship management event conditions.

As shown in FIG. 3, the shadowing service 300 may support a user provisioning interface to define the parameters required for collecting user interaction data and a data collection interface to receive only the provisioned subset of data. The shadowing service may use an engagement level related parameter vector (E.V.) and a competence level related parameter vector (C.V.). In addition, to gain detailed understanding of the in-application and in-game contexts, {[E.V., C.V., EoI]} may provide a unified service interface data format for modeling a set of application specific events and users action/reaction sequences representing a distinct context for [E.V., C.V.]. As disclosed herein, an event may represent the summary of state change. EoI may represent a summary of events that is of interest for representing [E.V., C.V.].

An example format of the EoI may be defined in Table 1.

TABLE 1
EoI : {

[

AppId, AppType,
TaskID, SubTaskID,
{

```
[ AppEvent, UserActionEvent, PoI ] //User react to
  App event; e.g., start shooting when an enemy is in
  range. Point of Interest (PoI) //zoom, monster cave,
  or geo location.
[UserActionEvent, AppEvent, PoI] //User event cause
  App event; e.g., moving into the monster zoom.
}
```

]
}
AppEvent: { EventObject: Pre-FSMState.X → Post-
FSMState.Y, TimeStamp, Duration, Input: [Event],
Output(Event)}
UserAction: { UserID, Pre-FSMState.X → Post-
FSMState.Y, TimeStamp, Duration, Input: [Events],
Output(Event)}
Event: {EventID, Event Object, EventDescription, ...}

The metric filter 306 and profiler 308 may analyze the parameters and contexts in [E.V., C.V., EoI] to generate engagement and competence levels, [E.L., C.L., EoI] as inputs to the real-time detection rules as described in the rule template use case.

The shadowing service 300 may generate levels of engagement or competence grouped by EoI to form a context aware behavior profile learned from the user interactions collected from EoI. The user behavior data processed by the metric filter 306 may be stored in a database 312. The user behavior data may be passed to the profiler 308 to generate summary levels E.L.′ and C.L.′, using the E.V. and C.V. generated from the metric filter 306, in a defined range such as [1:10] for each EoI for one or more users. The profile database 312 may support fast access and have a proximity search operator supporting content addressable and range search on EoI.

The summary levels generated by profiler 308 may include, but are not limited to, the following formats and may be accessible from a service interface uniform resource identifier (URI). A format may be URI.UserProfile: [E.V., C.V., E.L., C.L., EoI.URI]. A format may be a summary of application specific parameters used in [E.V., C.V.]. The summary of application specific parameters used in [E.V., C.V.] may include, but are not limited to a set of {Tag Name} for each user behavior indicator, such as Kill-Rate, Death-Rate, Points Gathered, or Scores. The summary may also include a mapping table {Selection, Weight) to define which subset of parameters are used to derive the behavior indicator and the weight of the parameters that can be adjusted by a developer.

The Tag may consist of multiple descriptors to specify an application specific object description and object property description. As shown in Table 2 and Table 3, an engagement parameter vector object may be listed in table form that allows developers and user behavior analysts to select and weight parameter tag fields for E.V. and C.V. The Tag field may support the configuration of EPF and the Weight field may support the profiling and the iterative adjustment of the importance level of a parameter to the behavior indicator (E.L., C.L.). The GameID, optional game level, user ID, and EoI may provide a finer granularity for a profiler to drill down to the user behavior with increasing level of detail. Table 2 shows an example of a configuration object for an engagement parameter listed in table form.

TABLE 2
Example of Parameter to Behavior Indicator Mapping
Engagement Parameter Vector Selection
and Weight Assignment Table, E.V.
Game ID: X1, [Optional: [Level ID: L3, UserID: U2, EoI: {. . .}]

| Tag | Weight | App Tag | Tag | Property |
|---|---|---|---|---|
| (EPF) | (Profile) | Name | Decryptions | Description |
| yes | NA | Session | Epoch time | 2015-09- |
| | | start time | | 16T23:59:59.50 |
| yes | 8 | Session | Minute | 3.5 minute |
| | | Duration | | |
| yes | NA | Session | Epoch time | 2015-09- |
| | | end time | | 16T23:59:59.50 |
| no | 0 | DamageTo | Brick \| | Enery \| Level \| Live |
| | | Others | Enemy \| | |
| | | | Base | |
| no | 0 | DamageTo | Avatar \| | Enery \| Level \| Live |
| | | Self | Vehicle \| | |
| yes | 5 | Number | Bullet \| | Counts |
| | | of shots | Arrow | |
| yes | 5 | Number | Enemy \| | Score \| Live \| Prize |
| | | of Kill | Monster | |
| yes | 7 | Number | Count | Score \| Live \| Prize |
| | | of Death | | |
| no | 0 | Network | RTT | 120 ms |
| | | Delay | | |
| no | 0 | Bandwidth | Client \| | 120 Kb/s |
| | | | ISP \| | |
| | | | Server | |
| yes | 7 | Task | Level \| | Scores \| Points |
| | | Completions | Quest \| | |
| | | | Puzzle | |
| yes | 9 | Task | Level \| | Counts |
| | | Attempts | Quest \| | |
| | | | Puzzle | |
| no | 0 | Win \| loss | AIID \| | Scores \| Points |
| | | | OpponentID | |
| no | 0 | Prize | | Points \| Weapons |
| | | earned | | |
| no | 0 | Point | | Points |
| | | earned | | |
| . . . | . . . | . . . | | |
| . . . | . . . | . . . | | |

Table 3 shows an example of a configuration object for a competence parameter listed in table form.

TABLE 3
Competence Parameter Vector Selection
and Weight Assignment Table, C.V.
Game ID: X1, [Optional: [Level ID: L3, UserID: U2, EoI: {. . .}]

| Tag | Weight | App Tag | Tag | Property |
|---|---|---|---|---|
| (EPF) | (Profile) | Name | Decryptions | Description |
| yes | NA | Session | Epoch time | 2015-09- |
| | | start time | | 16T23:59:59.50 |
| no | 0 | Session | Minute | 3.5 minute |
| | | Duration | | |
| yes | NA | Session | Epoch time | 2015-09- |
| | | end time | | 16T23:59:59.50 |
| yes | 5 | DamageToOthers | Brick \| | Enery \| Level \| |
| | | | Enemy \| | Live |
| | | | Base | |
| yes | 5 | DamageToSelf | Avatar \| | Enery \| Level \| |
| | | | Vehicle \| | Live |
| yes | 2 | Number | Bullet \| | Count |
| | | of shots | Arrow | |
| yes | 7 | Number | Enemy \| | Score \| Live \| |
| | | of Kill | Monster | Prize |
| yes | 7 | Number | Count | Score \| Live \| |
| | | of Death | | Prize |
| no | 0 | Network | RTT | 120 ms |
| | | Delay | | |
| no | 0 | Bandwidth | Client \| | 120 Kb/s |
| | | | ISP \| | |
| | | | Server | |
| yes | 9 | Task | Level \| | Scores \| Points |
| | | Completions | Quest \| | |
| | | | Puzzle | |
| yes | 9 | Win \| loss | AIID \| | Scores \| Points |
| | | | OpponentID | |
| yes | 9 | Prize | | Points \| Weapons |
| | | earned | | |
| yes | 9 | Point | | Points |
| | | earned | | |
| . . . | . . . | . . . | | |
| . . . | . . . | . . . | | |

The following Table 4 may provide an example of a Point of Interest (PoI) field in the EoI data model. The PoI field may be used to provide the context on virtual and physical location and the FSM state as well as the role and mode of the user avatar for each game. Table 4 shows an example of a PoI model for multiple game tasks and game contexts.

TABLE 4
Point of Interest Data Model

| GameID. | | | FSM | |
|---|---|---|---|---|
| SessionID. | Avatar | | Action | |
| TaskID | Role | Mode | States | Locations |
| G1.S2.TK3 | Avatar | Hint | Puzzle | Zone1 |
| | ID | | | |
| G2.S3.TK2 | Attacker | Play | Shoot | Zone4 |
| G3.S3.TK2 | CarType | Coach | Drive | Track 2 |
| G4.S3.TK2 | Defender | Play | Run | Base 3 |

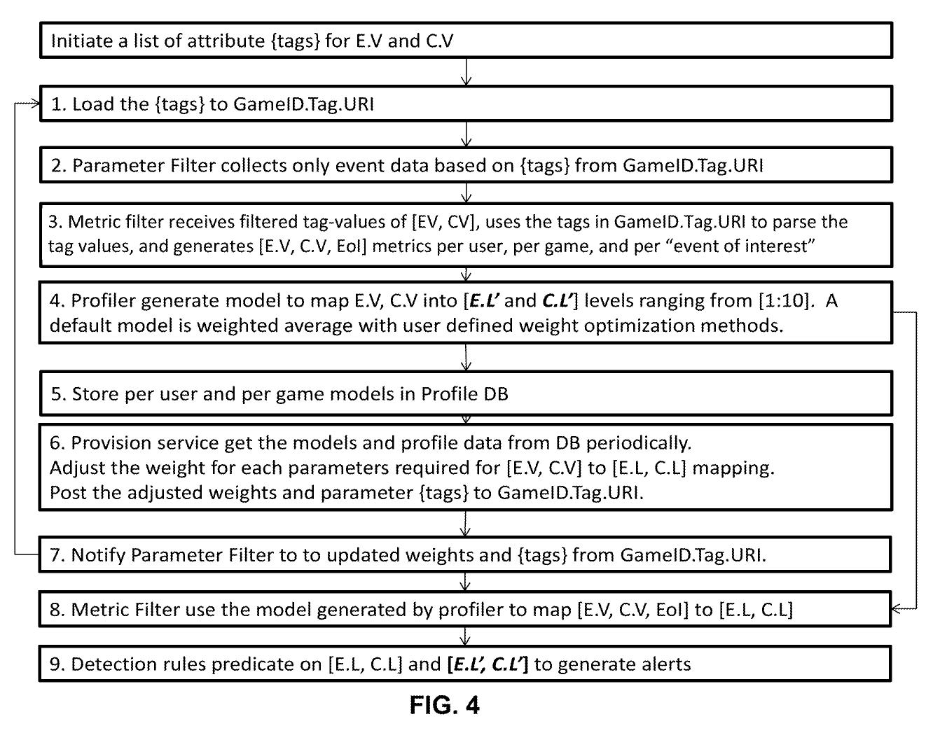

Referring now to FIG. 4, a flow chart illustrating iterative [E.V., C.V.] provisioning, filtering, and profiling steps is shown. The shadowing service 300 (FIG. 3) may support a workflow for iterative refinement of weights in the [E.V., C.V., EoI] to generate engagement level (E.L.) and competence level (C.L.) mapping.

An example mapping function may be used to calculate the E.L. and C.L. The input and output of an example function may be described as follows. The inputs may include {GamerID: “U1”, GameID: “G1”, E.V.: [Tag1: “Val1”, Tag2: “Val2”, . . . TagN: “ValN”]} per gamer, assuming that Gamer ID is known.

An example function may be obtained from a developer or service provider defined library function:

CompetenceLevel=CompLevelClassify(W, C.V.), Equation (1)

where W is a vector of weights defined in Tables 2 and 3. The CompLevelClassify function may be defined by a data analyst. The variable W may be adjusted based on frequency of occurrence or correlation with classified level using training set from multiple users.

The outputs may include: competence level [1:10]. The CompLevelClassify function may generate a competence level, C.L., from 1 to 10.

In an embodiment, the shadowing service 300 (FIG. 3) may enable multiple mobile applications and games to download and use the parameter filter 304 (FIG. 3) to support dynamic creation and configuration of behavior indicators comprising multiple application and game specific parameters. The shadowing service 300 may run in the same or different server with the application and game servers. The shadowing service 300 may provide a service application programming interface (API) and SDK native code libraries or scripts for multiple types of programming languages supporting different types of game or developer preference.

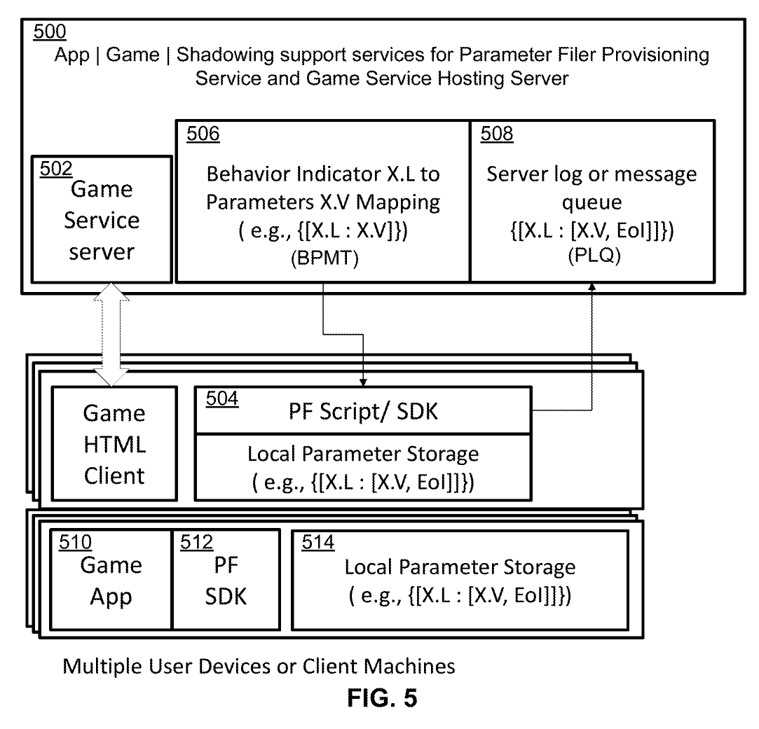

Referring now to FIG. 5, a diagram illustrating shadowing support services 500 for distributed parameter filters is shown. As shown in FIG. 5, the shadowing service 300 may provide multiple parameter filter support services including, but not limited to, a parameter filter interface script 504 or native code repository service (PFURI), a behavior indicator and application specific parameters mapping template (BPMT) 506 configuration and lookup service, and a parameter logging and queueing service (PLQ) 508.

The native code repository service (PFURI) may be a separate web service that may be located in a game service server 502 or in the shadowing service 500. It may allow for a developer to download code from a hosting server. The PFURI may provide version control for the shadowing service developer and may enable multiple game developers to download the binary library and/or scripts. The BPMT may provide a Web service API for developers and relationship management specialists to access the service. The PLQ 508 may provide a web service interface for applications and games 510 to send messages to the shadowing service server 500 so that the parameters can be logged or queued for reliable parallel processing. Example service interface APIs may include, but are not limited to queue (QueueID, AppID, Msg, SecureToken) and log (LogID, AppID, Msg, SecureToken).

The developer of an application or game may download the parameter filter code from the code repository service, PFURI. If the application is based on HTML5, a javascript version of the parameter filter (PF) script 504 may be provided by a game service server 502 in the runtime dynamically. The javascript version of the PF script 504 may allocate the local session storage to buffer the parameter temporarily and may send the summary parameters (e.g., a number of rabbits killed in the last 3 minute session) to the PLQ service 508. For a native application, a SDK library 512 may be used to dynamically link with an application event handler that may collect application events and store the parameter from the event to local storage. Upon startup, the PF SDK 512 may create a local parameter session storage object similar to the HTML5 local session storage to track and buffer the parameters in the same way as the HTML5 scripts described above.

The PF script 504 or native code may have a subscription and notification interface with the BPMT service. When developers change the parameters for a behavior indicator X defined in the template, X.V., or the weight inside the X.V. template, a notification may be sent to the application and activate the PF script 504 to update the parameter mapping template.

The developers of the mobile applications and games may use the BPMT service to load and create new instances of a mapping template for a new application or game. After that, the developer of the application or game may deploy the new template in the cloud with a URI to identify the template. For example, a template for a behavior indicator X.L. (e.g., E.L. or C.L.) may comprise parameters, E.V. (e.g., playtime and click rate) or C.V. (e.g., kill rate and prize earning rate).

The parameter filter script 504 or native code may access a local parameter storage 514 using the same tag-value notation (e.g., JavaScript Open Notation (JSON)) with the same serialization storage and messaging format. A Product Lifecycle Management (PLM) API may support serialization and insertion of application and action events in an EoI (e.g., a monster appears and killing the monster in an interaction sequence).

As an example, an EoI may be provided for the following Event of Interest. A game (application) AI may detect a player near a monster event. It may activate a monster X from idle state to fighting state and send a “Monster X Appear” event as output. On detecting the Monster X Appear event, player (user) actions may cause the player's Avatar to transition from a running state to a shooting state, and the shooting may last for two minutes before the monster is killed.

The EoI may capture all the state transitions, input events, and output events to provide the detailed player (user) interaction context for the selected output of event parameters. The parameter filter may provide the following EoI API for application developers: EoI.create to create an instance of the EoI; EoI.insert to insert a list of AppEvent, UserAction, and PoI to the EoI; EoI.serialize to convert EoI to a serialized string; and EoI.parse to deseriealize the EoI object.

The following examples describe steps to create, set, and send the parameters and EoI to using the service APIs.

TABLE 5
//Get the mapping template from BPMT service
C.V. = bpmt.new(AppID, SecureToken) // get a new instance of template
//Read and update the entry in the template.
//Update the entries with parameters extracted from the in-application
events bpmt.mp.create({Kill, Prize}, SecureToken) //insert new entries in
the template.
//update a parameter weight
bpmt.update({Kill.weight: 0.8}, SecureToken) //No of kill has weight of
0.8
//Delete parameter tag
bpmt.delete({DamageToOthers}, SecureToken) //delete the
damageToothers entry.

After a new instance of the mapping template is created, the parameter filter may populate the template with game event parameters defined in the template. The following example describes how the application may collect and store the template in local storage and send instances of parameters defined in the template to the shadowing service with the EoI attached.

TABLE 6
//Example of sending parameters to shadowing service.
//Detecting in-application or in-game events.
/*Application specific development. The PF can listen to the events
from the application or game. An application specific event handler
for each application will provide the entry point for PF to listen to.
The application event triggers the PF to get the parameters saved in
local storage and send to shadowing service. The application can use
the template obtained using the service API described earlier to
select only the events with parameters specified in the template*/
AppEventHandler( ){
//Get the in-application or in-game events
Get(event.ID, event.type, event.object, event.timestamp),
If the event contains parameter that are defined in the mapping
templates (e.g., E.V., C.V.) then do the following:

// get the state for application or user event.
Get(Pre-FSMState, Post-FSMState)
// get the point of interest location in game world and provide the
description such as monster cove, enemy base)
Get(PoI) ,
/*Insert the entries in EoI. EoI will be attached to the message
containing [X.V, EoI]*/
EoI : {

[

AppId, AppType,
TaskID, SubTaskID,
{

```
[ AppEvent: {EventID:X, EventObject: “monster X”,
  Pre-AppFSMState:Idle, Post_AppFSMState:fight,
  TimeStamp: epochTS1, Duration, Input: {EventID:
  “Y1”, PlayerID: U1, EventObject: “Player”,
  EventDescription: “Player in range”},
  Output:{EventID: W1, Description: “Monster X
  Appear”} ,
  UserAction: {“EventID: “A2”, PlayerID: “U1”,
  EventObject:”Monster X”, Pre-UserFSMState:
  “Running”, Post-UserFSMState: “Shooting”, Input:
  EventID: “Y2”, EventObject:”MonsterX”,
  EventDescription: “Monster X Appear” TimeStamp:
  EpochTimeTS2,
//Point of Interest
  Pol: Name: “Monster Cave”, GameWorldLocation :
```

Zoom 2” //

]}}.

//Instantiate the new instance of X.V parameter object to send to
the shadowing log service.
X.V = new bpmt(AppID, secureToken),
//Insert the parameter into the [X.V] template
X.V.Kill = {Kill:2, object: Rabits})
X.V.Prize = ({Prize:4, object:heart})
//send the selected parameter updates with the EoI to the server
log for the application.
plq.log(AppID, X.V, EoI, TimeStamp, secureToken),

In an embodiment, extended shadowing models may be used for event driven help services. On-line help may be an important type of user relationship management service feature that can be supported by the shadowing service with improved context awareness using the EoI. For conventional applications and games, manual user relationship management may be prohibitively costly to offer.

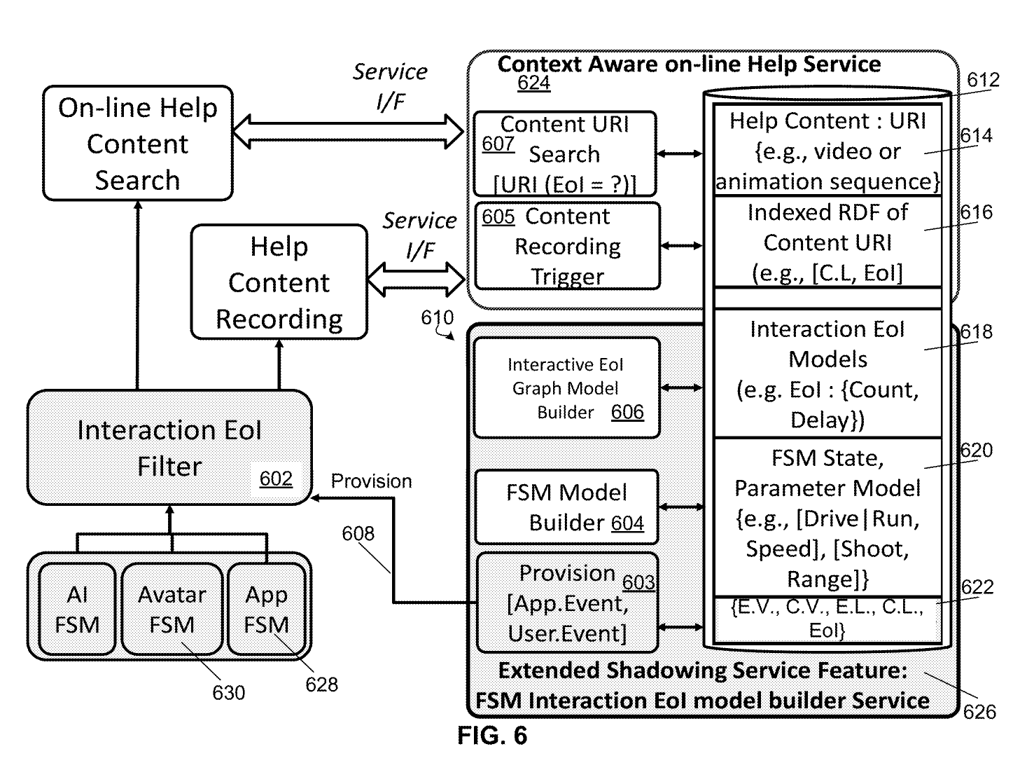

Referring now to FIG. 6, a diagram illustrating context aware on-line help services 624 is shown. The extended shadowing service 626 shown in FIG. 6 may support automatic online help based on detailed interaction events between the application and the user. As an example, the shadowing service 626 may capture causality between the application and user events. By learning the causality statistics, a more detailed interaction behavior may be tracked using the EoI data provided by the DEPF.

As an example, a sequence of interaction events may capture the “state transition” causality between the “application FSM” 628 and the “user avatar FSM” 630. An application event may occur, such as “monster appears” within the range of an attack. In a user FSM event, a player may respond to the monster appear event and change state from a running to a shooting or attacking state. The shooting state may use player FSM state parameters, when, for example, the player uses a type W weapon and shoots at a H hit/sec rate. In an application event, when the monster or the player is killed, an event of interest “EoI: monster killed or player removed” may be filtered and sent to the shadowing service.

The following example interactions may occur between application and user events. A player may shoot an enemy in the range of D meters on average and have an average kill-rate of K using the weapon type W. A player may use a type T tool to collect type R resources four times. Enemies may appear four times and the player's response time may be less than 250 ms on average. A player may fight a monster three times and, at the end, kill the monster and gain score S. A player may not fight when enemies appeared but, instead may run away three times.

After collecting these interaction events from an Interaction EoI filter 602 for one or more users, a model builder 610 may build interaction behavior models for these users. With the behavior models, the system may compare the level of the user's real-time behavior against that in the models.

Examples of the FSM state and cross FSM interaction causality model may include, but are not limited to, the following. An FSM state parameter model 604 may include, but is not limited to: running speed (e.g., avg/std), shooting range, puzzle solving time, monster battle time, progress (e.g., score, win rate and kill rate).

An interactive EoI graph model builder 606 may include, but is not limited to: [EoI Application event, predicate, User Action model, parameter, LinktoNextNode]. The predicate may be [Cause|After|Is . . . ] and the parameter may be [OccurrenceCount-statistics, ReactionTimeDelay statistics, others]. The parameter may be for, example, avg, std, K-mean, or clustering. The interactive EoI graph model builder 606 may include lower level service log and message queue functions. A provision function 603 may include X.L. to X.V. mapping.

A service interface 608 between the Interaction EoI filter 602 and the model builder 610 may include [Application FSM state, User FSM state, predicate, Parameter [OccurrenceCount: X (times), ReactiontimeDelay: D min, EoI]]. The application developer may also use an open service interface to look up the interaction models, which may support the game design improvement or new game features. For example, a developer may obtain a comparative analysis report on a user engagement level of similar game types or a population density on engagement levels under different EoIs (e.g., kill monster types 1, treasure hunt type 3, and race track 5). The developer may also obtain a report on average reaction time of one or more players and adjust the pace of the game to support dynamic game leveling using the shadowing service cost effectively.

The online help service feature 624 shown in FIG. 6 may have one or more functions. In a pre-recording trigger for content storage (i.e., Content Recording Trigger) function 605, players may continuously record action events, avatar behavior, and/or machinima video. The pre-recorded content may be selected portions of recording before and after an EoI, such as achieving a victory in short period of time or killing a monster in a specific game session. In an on-line context aware search (i.e., Content URI Search) function 607, when detecting the player having a problem, the EoI of the player may be used to search the EoI in the database and select the pre-recorded content that matches the EoI.

To support seamless and non-intrusive display of on-line help, the data models and event pattern detection rules may be used for synchronizing the on-line help content with the user action EoI. For example, a search query may match the EoI of pre-recorded help contents with the EoI of the user to select the pre-recorded video or animations content. The EoI may have a time span for pre-recording (T minutes) before the ending EoI, such as “Kill the monster M”, “Solve Puzzle P”, or “Complete track T.” A set of EoI examples may include, but is not limited to, the following: kill a Big-monster in game zone 2, fail a puzzle in puzzle 2 of level 3, pass a level in 3rd try or after failing twice, pick up a weapon in game zone 2 room 3, start running near way-point 2, stop running before a pool in zone 5, and hide in a behind a corner near the door of zone 4.

The extended shadowing service function 626 and the on-line help service function 624 may share a common database 612 consisting of one or more functions. The functions may include, but are not limited to, the following: Help Content : URI 614 (e.g., video or animation sequence); Indexed RDF of Content URI 616 (e.g., [C.L., EoI]); Use format like RDF to provide a common representation such as [AppEvent: Event X, predicate:cause, UserEvent: Y, parameters:{Count, Delay, . . . }, LinktoNextNodeURI]; Interaction EoI Models 618 (e.g., EoI: {Count, Delay}); FSM State, Parameter Model 620 (e.g., [Drive|Run, Speed], [Shoot, Range]); and {E.V., C.V., E.L., C.L., EoI} 622.

In an embodiment, an extended method may be used for iterative behavior pattern adjustment. A profiling parameter recommendation service may automatically observe the in-application parameters from EoI and incrementally reduce the number of events using the EoI Event Interaction Filter. The filter may initially monitor all the FSM transitions and user actions inputs and outputs to extract all the parameters and populate the parameter selection table described above.

After receiving the initial dataset, the profiler may learn from the E.V. and C.V. correlation and distribution and may decide the mapping to E.L. and C.L. The profiler may use the Score, Skill level, and/or Win Rate as references for evaluating parameters in E.V. and C.V. and may recommend new parameters dynamically to developers and CRM specialists. For example, in one case, DamageToOthers may be less effective than the ratio of DamageToOther/DamageToSelf for determining the competence level of a user. In another case, session time may be less effective for engagement level than the occurrence and delay of interaction events between the Als of games and/or players. In other cases, a simple score and score rate may be sufficient to capture the competence and engagement level, respectively.

The profiler may use business-related performance indicators such as retention rate, user satisfaction, improvement on user performance, and purchase of premium packages as parameters to evaluate the correlation between the time series parameters in E.V. and C.V. and the time series in the high-level performance indicators. The highly correlated parameters may be given a higher weight.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of detecting user behavior patterns across one or more applications having diverse data sources and contexts, the method comprising:
collecting a subset of user event data from an application in real-time, wherein the subset of user data is defined by one or more application-specific parameters tagged for collection in a mapping template comprising high-level application independent user behavior indicators;
assigning a weight to each of the one or more application-specific parameters tagged for collection;
generating an engagement vector and a competence vector based on a combination of the one or more weighted application-specific parameters;
generating one or more metrics from the engagement vector and the competence vector, wherein the one or more metrics comprise statistics specific to one or more of the user, the application, or an event of interest in the application;
assigning a competence level and an engagement level for a second application to the user based on the one or more metrics; and
generating a user retention action for the second application based on the competence level and the engagement level.

2. The method of claim 1, wherein the collecting the subset of user event data comprises:
determining how the user responds to events in the application;
determining how the user initiates actions in the application; and
recording the learned responses and actions.

3. The method of claim 1, wherein the engagement level and the competence level comprise high-level behavior indicators that are application independent.

4. The method of claim 1, wherein the high-level application independent user behavior indicators are transparent to application-specific parameters.

5. The method of claim 1, wherein the mapping template comprises an open interface allowing the selection of user behavior patterns tailored to the context of one or more applications.

6. (canceled)

7. The method of claim 1, further comprising:
defining an active Event of Interest (EoI) object model to capture events of interest generated from a finite state transition in the application caused by an event or user input.

8. (canceled)

9. (canceled)

10. The method of claim 7, wherein the EoI object model includes a Point of Interest (PoI) field comprising one or more of a virtual location context, physical location context, Finite State Machine (FSM) action state, role of the user, and mode of the user.

11. A server for detecting user behavior patterns across one or more applications having diverse data sources and contexts, the server comprising:
a communications interface;
a memory coupled to the communications interface, wherein the memory stores an electronic request processing application; and
a processor in communication with the memory, the processor configured to:
collect, through the communications interface, a subset of user event data from an application in real-time, wherein the subset of user data is defined by one or more application-specific parameters tagged for collection in a mapping template comprising high-level application independent user behavior indicators,
assign a weight to each of the one or more application-specific parameters tagged for collection,
generate an engagement vector and a competence vector based on a combination of the one or more weighted application-specific parameters,
generate one or more metrics from the engagement vector and the competence vector, wherein the one or more metrics comprise statistics specific to one or more of the user, the application, or an event of interest in the application,
assign a competence level and an engagement level for a second application to the user based on the one or more metrics, and
generate a user retention action for the second application based on the competence level and the engagement level.

12. The server of claim 11, wherein the collecting the subset of user event data comprises:
determining how the user responds to events in the application;
determining how the user initiates actions in the application; and
recording the learned responses and actions.

13. The server of claim 11, wherein the engagement level and the competence level comprise high-level behavior indicators that are application independent.

14. The server of claim 11, wherein the high-level application independent user behavior indicators are transparent to application-specific parameters.

15. The server of claim 11, wherein the mapping template comprises an open interface allowing the selection of user behavior patterns tailored to the context of one or more applications.

16. (canceled)

17. The server of claim 11, wherein the processor is further configured to:
define an active Event of Interest (EoI) object model to capture events of interest generated from a finite state transition in the application caused by an event or user input.

18. (canceled)

19. (canceled)

20. The server of claim 17, wherein the EoI object model includes a Point of Interest (PoI) field comprising one or more of a virtual location context, physical location context, Finite State Machine (FSM) action state, role of the user, and mode of the user.

21. The method of claim 1, further comprising:
dynamically adjusting the weight to each of the one or more application-specific parameters tagged for collection.

22. The method of claim 1, further comprising:
storing the competence level and the engagement level in a database accessible to the other applications.

23. The server of claim 11, wherein the weight assigned to each of the one or more application-specific parameters tagged for collection is adjusted dynamically.

24. The server of claim 11, wherein the processor is further configured to store the competence level and the engagement level in a database accessible to the other applications.

25. The method of claim 1, wherein the generating a user retention action for the second application comprises:
detecting that the user is having a problem with an event within the second application; and
automatically playing pre-recorded content that matches the event to assist the user.

26. The server of claim 11, wherein the generating a user retention action for the second application comprises:
detecting that the user is having a problem with an event within the second application; and
automatically playing pre-recorded content that matches the event to assist the user.
